(19) United States
(12) Patent Application Publication
(10) Pub. No.: US 2026/0054998 A1
(43) Pub. Date: Feb. 26, 2026

(54) POROUS MICRON-SIZED SILICON BALL MATERIAL AND PREPARATION METHOD THEREFOR AND USE THEREOF

(71) Applicant: WUHAN UNIVERSITY OF SCIENCE AND TECHNOLOGY, Wuhan (CN)

(72) Inventor: Biao Gao, Wuhan (CN)

(21) Appl. No.: 18/812,965

(22) Filed: Aug. 22, 2024

(51) Int. Cl. C01B 33/023; H01M 4/02; H01M 4/134; H01M 10/0525

(52) U.S. Cl. CPC C01B 33/023; H01M 4/134; C01P 2002/01; C01P 2002/72; C01P 2004/03; C01P 2004/04; C01P 2004/32; C01P 2004/61; C01P 2006/40; H01M 2004/027; H01M 10/0525

(57) ABSTRACT

The present disclosure provides a method for preparing a porous micron-sized silicon ball negative electrode material, including the following steps: performing high-temperature expansion and mechanical ball milling on a layered silicate raw material, and purifying same by hydrochloric acid washing to obtain a layered silicon dioxide; mixing the layered silicon dioxide with aluminum powder, sodium chloride and aluminum chloride, putting the mixture into a reaction container, and heating the mixture to perform a reduction reaction; and washing the reaction product by using a hydrochloric acid and hydrofluoric acid solution, then performing suction filtration to be neutral, and vacuum-drying same to obtain the porous micron-sized silicon ball.

### TECHNICAL FIELD

The present disclosure belongs to the technical field of lithium ion batteries and particularly relates to a porous micron-sized silicon ball material and a preparation method therefor and use thereof.

### BACKGROUND

Lithium ion batteries are important energy storage devices and have been widely used in the fields of consumer electronics, electric vehicles, energy storage and the like. The theoretical specific capacity of the current commercial graphite negative electrode is 372 mAh/g, which cannot meet the application requirement. It is a necessary way to develop a high-capacity negative electrode material for improving the energy density of the batteries. Silicon has the theoretical capacity 10 times that of graphite and thus is an ideal negative electrode material for next-generation high-specific-energy batteries. However, the large volume change (>300%) of Si during lithium deintercalation is liable to cause mechanical pulverization of particles, the electrical contact between the particles is lost, and a solid-electrolyte interphase film (SEI) continuously grows, thereby causing rapid fading of the capacity and deterioration of the battery performance.

In order to buffer the pulverization problem caused by the volume change of Si in the charging and discharging processes and improve the structural stability of an electrode material, scientific researchers focus on the nanocrystallization of Si, and various nanostructures such as nanowires, nanoporous structures, nanotubes, nanoslices and the like make great progress in solving the problem of pulverization of Si particles and improving the battery performance. However, the nano preparation process is complex, the preparation cost is relatively high, and the tap density and the initial coulombic efficiency of the nanostructures hardly meet the requirements of practical application, thereby hindering the large-scale process of the nanostructures. Micron-sized silicon-based materials have natural advantages in terms of the cost, tap density and coulombic efficiency, and are more attractive than nanoscale materials in industrial production.

Chinese patent CN109694075A discloses a method for preparing low-temperature ball-milled nano silicon powder, comprising mixing and a silicon source, aluminum powder or magnesium powder and a reaction promoter, grinding same, then performing batch-type ball-milling reaction at 95-160° C. for 6-8 hours to obtain a prefabricated nano silicon powder, spraying deionized water, adding hydrochloric acid for reaction, and washing same with hydrofluoric acid to obtain the nano silicon powder. The method is complicated in preparation process. The particle size of prepared silicon balls is 30-10 nm and low in the tap density. Besides, the silicon balls are seriously sintered.

Chinese patent CN108666560A discloses a method for preparing a nano silicon material, comprising mixing silicon raw material particles, a low-melting-point metal salt and a metal with a strong reducing property, ball-milling same to obtain a nano silicon material precursor, and water washing, acid washing and drying same to obtain the nano silicon material. The method also has a complicated preparation process, the particle size of the prepared silicon material is 100-650 nm and the tap density is low, which cannot meet the requirement of practical application.

In light of this, it is of important significance for the development of the lithium ion batteries to develop a silicon negative electrode material which is simple in preparation process, high in tap density and stable in structure, and has the advantages of long-acting circulation, excellent rate capability, small swelling rate of an electrode membrane.

### SUMMARY

Aiming at the existing problems in the prior art, the present disclosure provides a porous micron-sized silicon ball negative electrode material and a preparation method therefor and use thereof. The material has various sources, is simple in the preparation method and low in cost, can realize the advantages of micron-sized silicon in the cost, tap density and coulombic efficiency, can also reserve enough space inside to relieve volume expansion, and realizes an excellent cycle performance.

In order to achieve the above objectives, the technical solutions adopted by the present disclosure are as follows:

A method for preparing a porous micron-sized silicon ball material, including the following steps:
(1) performing high-temperature expansion and mechanical ball milling on a layered silicate raw material, and purifying same by hydrochloric acid washing to obtain a layered silicon dioxide;
(2) mixing the layered silicon dioxide with aluminum powder, sodium chloride and aluminum chloride, putting the mixture into a reaction container, and heating the mixture to perform a reduction reaction; and
(3) washing the reaction product obtained in step (2) by using a hydrochloric acid and hydrofluoric acid solution, then performing suction filtration to be neutral, and vacuum-drying same to obtain the porous micron-sized silicon ball material.

In some embodiments of the present disclosure, in step (1), the layered silicate is selected from one or more of vermiculite, montmorillonite, talcum and kaolin.

The high-temperature expansion in step (1) refers to calcining the layered silicate raw material into 500-1,500° C. and naturally cooling same, further preferably, calcining the layered silicate raw material into 800-1,200° C. and naturally cooling same.

In step (1), after the mechanical ball milling, the size is preferably controlled to 1-100 μm, further preferably 5-50 μm.

In some embodiments of the present disclosure, in step (2), the mass ratio of the layered silicon dioxide, the aluminum powder, the sodium chloride and the aluminum chloride is 1:(0.5-1.5):(0.5-10):(6.25-18.75), further preferably, 1:(0.7-1):(2-5):(8.75-12.5), most preferably, 1:0.8:2.875:10.

In step (2), the reduction reaction is performed at the temperature of 200-600° C., further preferably 250-400° C. for 6-20 h, further preferably 10-14 h.

The layered silicon dioxide is mixed with the aluminum powder, the sodium chloride and the aluminum chloride at the specific ratio in the disclosure, and the mixture is subjected to a heating reaction and forms a liquid phase in AlCl₃ at the high temperature and high pressure. The surface tension of a ball is minimum under the condition of the liquid phase, such that the layered silicon dioxide slice is prone to curling into the ball. The van der Waals force between layers is further reduced by adding a sodium chloride molten salt, such that the layered silicon dioxide is easier to curl into the ball, the layer cannot curl into the ball at the low temperature, and the ball is destroyed and collapses at the high temperature. When the ratio of the aluminum powder to the aluminum chloride is too low, the silicon dioxide cannot be effectively reduced. When the proportions of the aluminum powder and the aluminum chloride are too low, the silicon dioxide cannot be effectively reduced. When the proportion of the sodium chloride is too low, the van der Waals force between the silicon dioxide layers cannot be effectively weakened. When the proportion of the sodium chloride is too high, the layered silicon dioxide is completely peeled into slices.

The size of the porous micron silicon ball prepared by the disclosure is about 1-30 μm. A micron-sized micron ball structure is obtained by wrapping nano silicon slices with a nano silicon shell. The material inside is the nano silicon slices or slightly sintered silicon slices and the outside is the silicon shell formed by curling the two-dimensional silicon slices. By utilizing the natural curling of the layered silicate in the liquid phase to form the ball, an enough “breathing space” can be reserved among the nanoslices in the micron-sized silicon ball to relieve the expansion of the micron-sized silicon in the process of lithium intercalation and lithium deintercalation. During the preparation process, the size of the layered silicate raw material needs to be strictly controlled. If the particle size of the raw material is too large, the van der Waals force and the bending resistance between the layers can keep the layer from curling into the ball in the reduction process. But if the particle size of the raw material is too small, a nano silicon ball is formed.

The present disclosure further provided use of the porous micron-sized silicon ball in the preparation of a negative electrode material of a lithium ion battery, and the lithium ion battery contains the porous micron-sized silicon ball of the present disclosure. The lithium ion battery includes a positive electrode plate, a negative electrode plate, a separator and an electrolyte. The negative electrode plate contains the porous micron-sized silicon ball material of the present disclosure.

Compared with the prior art, the present disclosure has the following beneficial effects:
the porous micron-sized silicon ball negative electrode material of the present disclosure is simple in preparation process, wide in raw material source, large in tap density and stable in structure, and has very good commercial application prospect due the advantages of long-acting circulation, excellent rate capability, small swelling rate of an electrode membrane and the like when used in a lithium ion battery.

### BRIEF DESCRIPTION OF THE DRAWINGS

FIG. 1 is an XRD pattern of a micron-sized silicon ball prepared by aluminothermic reduction at different heating temperatures in example 1 of the present disclosure;

FIG. 2 is an SEM pattern of the micron-sized silicon ball prepared by the aluminothermic reduction at different heating temperatures in example 1 of the present disclosure;

FIG. 3 is a TEM pattern of the micron-sized silicon ball prepared by the aluminothermic reduction in example 1 of the present disclosure;

FIG. 4 shows the cycle performance of the micron-sized silicon ball prepared by the aluminothermic reduction in example 1 of the present disclosure; and

FIG. 5 shows the rate capability of the micron-sized silicon ball prepared by the aluminothermic reduction in example 1 of the present disclosure.

### DETAILED DESCRIPTION

The technical solutions in the examples of the present disclosure are clearly and completely described below. Apparently, the described examples are merely some rather than all of the examples of the present disclosure. All other examples obtained by persons of ordinary skill in the art based on the examples of the present disclosure without creative efforts shall fall within the protection scope of the present disclosure. In addition, it is worth noting that the raw materials related in the present disclosure are common commercially available products unless otherwise specified.

### Example 1

Commercial vermiculite was selected, calcined to 900-1,100° C. at the high temperature and naturally cooled. The particle size was controlled to be about 5-10 μm through mechanical ball milling and gradient centrifugation. Layered silicon dioxide was obtained by purification through 10% hydrochloric acid washing. The layered silicon dioxide was mixed with aluminum powder, sodium chloride and aluminum chloride at the mass ratio of 1:0.8:2.875:10, and the mixture was put into a reaction container and subjected to a heating reaction in the reaction container at 200-350° C. for 12 h. The reaction product obtained in above step was washed by using a hydrochloric acid and hydrofluoric acid solution, and then subjected to suction filtration to be neutral and vacuum-drying.

### Experimental Results

FIG. 1 was an XRD pattern of a micron-sized silicon ball obtained at different temperatures. When the temperature was lower, a SiO2 peak still existed. With the increase of the reduction temperature, the SiO2 peak gradually weakened and finally disappeared, while a silicon peak gradually strengthened, indicating that the reduction rate of silicon gradually increased with the increase of the temperature.

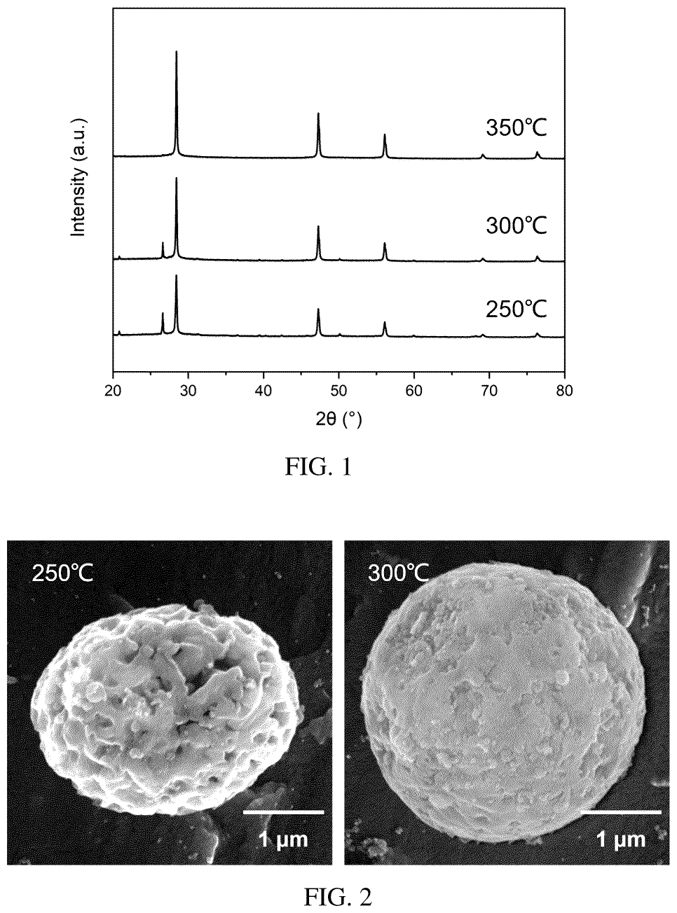

FIG. 2 was an SEM pattern of the micron-sized silicon ball obtained at different temperatures. When the temperature was lower, the surface of the silicon ball was in a porous structure similar to a skeleton. When the temperature was increased, no obvious hole was left in the surface of the micron-sized silicon ball and the ball shape was complete.

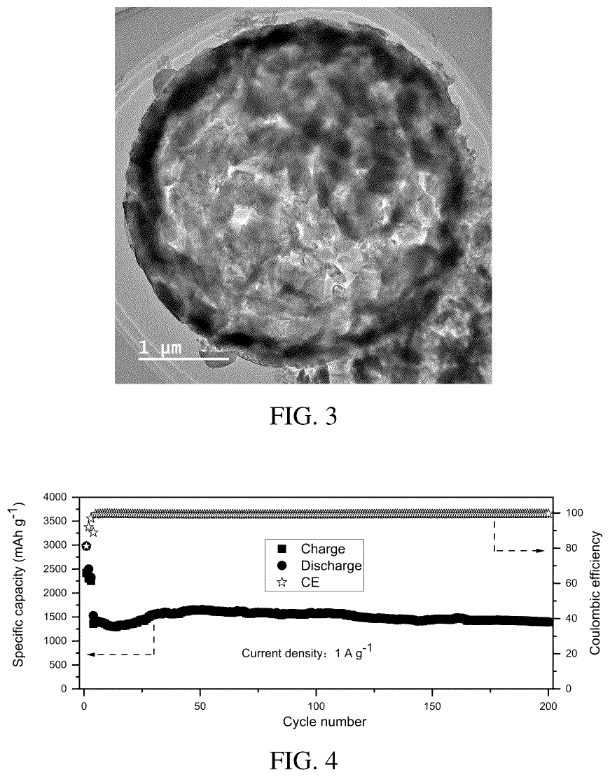

FIG. 3 was a TEM pattern of the micron-sized silicon ball. In the figure, the ball shape was complete. It can be obviously seen that a nanoslice structure was wrapped inside the silicon ball, an enough space was left among the nanoslices inside so as to effectively relieve the volume expansion during the process of lithium intercalation and deintercalation of the micron-sized silicon ball, such that the micron-sized silicon ball had the good cycle performance.

FIG. 4 showed the cycle performance of the micron-sized silicon ball. The first three circles were activation by using a low current at 0.1 Ag⁻¹ and then charge and discharge were performed to 200 circles at 2 Ag⁻¹. The result showed that the micron-sized silicon ball can still maintain the high reversible capacity of 1,400 mAhg⁻¹ after 200 circles of circulation and the coulombic efficiency after the activation was close to 100%, indicating that the micron-sized silicon ball had the excellent cycle performance.

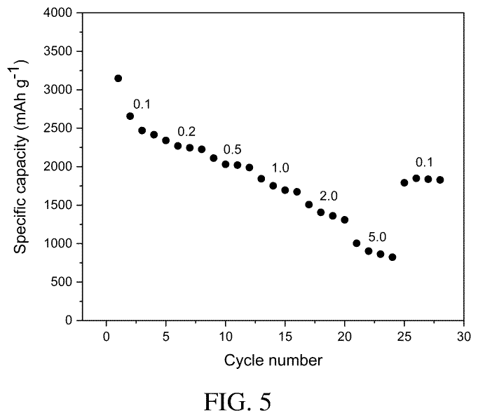

FIG. 5 showed the rate capability of the micron-sized silicon ball. The micron-sized silicon ball had the high reversible capacity of 2,435 mAhg⁻¹ under the current density of 0.1 Ag⁻¹. When the current density was increased to 1 Ag⁻¹, the reversible capacity of 1,673 mAhg⁻¹ was still achieved and the capacity retention rate was 68.7%. The high reversible capacity of 824 mAhg⁻¹ can be still maintained under the greater current of 5 Ag⁻¹.

### Comparative Example 1

Commercial vermiculite was selected and not subjected to high-temperature calcining and mechanical ball milling. Layered silicon dioxide was obtained by purification through 10% hydrochloric acid washing. The layered silicon dioxide was mixed with aluminum powder, sodium chloride and aluminum chloride at the mass ratio of 1:0.8:2.875:10, and the mixture was put into a reaction container and subjected to a heating reaction in the reaction container at 200-350° C. for 12 h. The reaction product obtained in above step was washed by using a hydrochloric acid and hydrofluoric acid solution, and then subjected to suction filtration to be neutral and vacuum-drying.

In the comparative example, micron-sized silicon prepared from the vermiculite not subjected to high-temperature expansion and ball milling was in a block shape, and a micron-sized silicon ball cannot be obtained.

### Comparative Example 2

Commercial vermiculite was subjected to mechanical ball milling and gradient centrifugation to control the particle size to be about 5-10 μm. Layered silicon dioxide was obtained by purification through 10% hydrochloric acid washing. The layered silicon dioxide was mixed with aluminum powder, sodium chloride and aluminum chloride at the mass ratio of 1:0.8:2.875:10, and the mixture was put into a reaction container and subjected to a heating reaction in the reaction kettle at 200-350° C. for 12 h. The reaction product obtained in above step was washed by using a hydrochloric acid and hydrofluoric acid solution, and then subjected to suction filtration to be neutral and vacuum-drying.

The micron-sized silicon obtained by the comparative example was in a block shape, indicating that the vermiculite not subjected to the high-temperature expansion and only subjected to ball milling cannot be prepared into a micron-sized silicon ball.

### Comparative Example 3

Commercial vermiculite was calcined to 900-1,100° C. at the high temperature and naturally cooled. Layered silicon dioxide was obtained by purification through 10% hydrochloric acid washing. The layered silicon dioxide was mixed with aluminum powder, sodium chloride and aluminum chloride at the mass ratio of 1:0.8:2.875:10, and the mixture was put into a reaction container and subjected to a heating reaction in the reaction kettle at 200-350° C. for 12 h. The reaction product obtained in above step was washed by using a hydrochloric acid and hydrofluoric acid solution, and then subjected to suction filtration to be neutral and vacuum-drying.

The micron-sized silicon obtained by the comparative example was in a block shape, indicating that the vermiculite only subjected to the high-temperature expansion and not subjected to ball milling cannot be prepared into a micron-sized silicon ball.

### Comparative Example 4

Commercial expanded vermiculite was selected, calcined to 900-1,100° C. at the high temperature and naturally cooled. The particle size was controlled to be about 5-10 μm through mechanical ball milling and gradient centrifugation. Layered silicon dioxide was obtained by purification through 10% hydrochloric acid washing. The layered silicon dioxide was mixed with aluminum powder and aluminum chloride at the mass ratio of 1:0.8:10, and the mixture was put into a reaction container and subjected to a heating reaction in the reaction kettle at 200-350° C. for 12 h. The reaction product obtained in above step was washed by using a hydrochloric acid and hydrofluoric acid solution, and then subjected to suction filtration to be neutral and vacuum-drying.

The micron-sized silicon obtained by the comparative example was in a block shape, indicating that a Van der Waals force between layers of the layered silicon dioxide cannot be further weakened under the condition of not adding a fused salt sodium chloride, and thus a micron-sized silicon ball cannot be obtained.

Finally, it should be noted that the above content is only intended to describe the technical solutions of the present disclosure, rather than to limit the protection scope of the present disclosure. Simple modifications or equivalent replacements to the technical solutions of the present disclosure made by a person of ordinary skill in the art all do not depart from the essence and scope of the technical solutions of the present disclosure.

What is claimed is:

1. A method for preparing a porous micron-sized silicon ball material, comprising the following steps:
(1) performing high-temperature expansion and mechanical ball milling on a layered silicate raw material, and purifying same by hydrochloric acid washing to obtain a layered silicon dioxide;
(2) mixing the layered silicon dioxide with aluminum powder, sodium chloride and aluminum chloride, putting the mixture into a container, and heating the mixture to perform a reduction reaction; and
(3) washing the reaction product obtained in step (2) by using a hydrochloric acid and hydrofluoric acid solution, then performing suction filtration to be neutral, and vacuum-drying same to obtain the porous micron-sized silicon ball material.

2. The preparation method according to claim 1, wherein in step (1), the layered silicate is selected from one or more of vermiculite, montmorillonite, talcum and kaolin.

3. The preparation method according to claim 1, wherein in step (1), the high-temperature expansion is performed at the temperature of 500-1,500° C., further preferably 800-1,200° C.; and after the mechanical ball milling, the size is controlled to 1-100 μm, further preferably 5-50 μm.

4. The preparation method according to claim 1, wherein in step (2), the mass ratio of the layered silicon dioxide, the aluminum powder, the sodium chloride and the aluminum chloride is 1:(0.5-1.5):(0.5-10):(6.25-18.75), further preferably, 1:(0.7-1):(2-5):(8.75-12.5), most preferably, 1:0.8:2.875:10.

5. The preparation method according to claim 1, wherein in step (2), the reduction reaction is performed at the temperature of 200-600° C., further preferably 250-400° C. for 6-20 h, further preferably 10-14 h.

6. A porous micron-sized silicon ball material prepared by the method according to claim 1.

7. Use of the porous micron-sized silicon ball material according to claim 6 in a negative electrode material of a lithium ion battery.

8. A negative electrode material of a lithium ion battery, comprising the porous micron-sized silicon ball material according to claim 6, a conductive agent and a binder.

9. A porous micron-sized silicon ball material prepared by the method according to claim 2.

10. Use of the porous micron-sized silicon ball material according to claim 9 in a negative electrode material of a lithium ion battery.

11. A negative electrode material of a lithium ion battery, comprising the porous micron-sized silicon ball material according to claim 9, a conductive agent and a binder.

12. A porous micron-sized silicon ball material prepared by the method according to claim 3.

13. Use of the porous micron-sized silicon ball material according to claim 12 in a negative electrode material of a lithium ion battery.

14. A negative electrode material of a lithium ion battery, comprising the porous micron-sized silicon ball material according to claim 12, a conductive agent and a binder.

15. A porous micron-sized silicon ball material prepared by the method according to claim 4.

16. Use of the porous micron-sized silicon ball material according to claim 15 in a negative electrode material of a lithium ion battery.

17. A negative electrode material of a lithium ion battery, comprising the porous micron-sized silicon ball material according to claim 15, a conductive agent and a binder.

18. A porous micron-sized silicon ball material prepared by the method according to claim 5.

19. Use of the porous micron-sized silicon ball material according to claim 18 in a negative electrode material of a lithium ion battery.

20. A negative electrode material of a lithium ion battery, comprising the porous micron-sized silicon ball material according to claim 18, a conductive agent and a binder.
